(19) United States
(12) Patent Application Publication
(10) Pub. No.: US 2007/0195442 A1
(43) Pub. Date: Aug. 23, 2007

(54) Actuator

(75) Inventors: Sang-Jae Song, Suwon-si (KR); Chil-Sung Lee, Suwon-si (KR); Ho Lee, Hwaseong-si (KR); Young-Jin Bae, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/704,391

(22) Filed: Feb. 9, 2007

(30) Foreign Application Priority Data
Feb. 9, 2006 (KR) 10-2006-0012362

(51) Int. Cl. G02B 7/182

(52) U.S. Cl. 359/875

(57) ABSTRACT

An actuator is disclosed. The actuator, which includes a base; a shaft, of which one end is rotatably joined to the base; a case secured to the other end of the shaft; a magnet mounted on one side of the case; a coil secured to the base to face the magnet; a mirror joined to the case and positioned on a light path to reflect light; and a guide having a guide hole that is capable of controlling the rotation angle of the mirror, not only has a small volume to be applicable to a mobile terminal, but also allows easy control of the mirror.

### CROSS-REFERENCE TO RELATED APPLICATIONS

This application claims the benefit of Korean Patent Application No. 10-2006-0012362 filed with the Korean Intellectual Property Office on Feb. 9, 2006, the disclosure of which is incorporated herein by reference in its entirety.

### BACKGROUND

1. Technical Field

The present invention relates to an actuator.

2. Description of the Related Art

Although the mainstream product in today's mobile terminal is the camera phone, which is equipped with a camera function, the commercialization of mobile terminals such as the DMB phone, etc., that are capable of image services, has led to a demand for larger display screens. Accordingly, the mobile terminal is becoming larger in thickness or volume, in order to further enlarge the display screen. However, even though the display screens have become larger in current mobile terminals for image or video services, there are limitations in providing a display screen size that is satisfactory to users.

A method proposed to resolve these problems is to apply a miniature image projection system to portable phones or PDA's, etc., whereby a user may project the videos or images to a screen or a wall surface. Such an image projection system-has the advantage of reducing the volume of the mobile terminal while providing a display of a satisfactory size.

In current image projection processing systems, the light from one or more light sources is reflected by mirrors that are made to vibrate by actuators, to implement magnified images. As such, due to the limit in volume of the terminal, a small size is required for those actuators applied to a mobile terminal. Also, it is required that the actuators provide easy initialization and control of the positions of the mirrors, as well as lower power consumption.

### SUMMARY

An aspect of the invention is to provide an actuator applicable to a mobile terminal.

Another aspect of the invention is to provide an actuator which allows easy initialization and control of the position of a mirror.

One aspect of the invention provides an actuator which includes a base; a shaft, of which one end is rotatably joined to the base; a case secured to the other end of the shaft; a magnet mounted on one side of the case; a coil secured to the base to face the magnet; a mirror joined to the case and positioned on a light path to reflect light; and a guide having a guide hole that is capable of controlling the rotation angle of the mirror.

The actuator according to embodiments of the invention may include one or more of the following features. For example, a holder which secures the mirror may be formed on an upper portion of the case, with the holder inserted into the guide hole. Also, the actuator may further include a Hall sensor secured to one side of the base and facing the magnet, and a control unit which controls the rotation of the mirror using a signal detected by the Hall sensor, while the guide hole may have a bilaterally symmetrical fan-like shape. Furthermore, the base may have a boss supporting the shaft, and a bearing may be interposed between the boss and the shaft.

Additional aspects and advantages of the present invention will become apparent and more readily appreciated from the following description, including the appended drawings and claims, or may be learned by practice of the invention.

### BRIEF DESCRIPTION OF THE DRAWINGS

FIG. 1 is a cross-sectional view of an actuator according to an embodiment of the invention.

FIG. 2 is a perspective view showing a holder inserted into a guide.

FIG. 3 is a plan view of a guide having a guide hole.

### DETAILED DESCRIPTION

Embodiments of the invention will now be described below in more detail with reference to the accompanying drawings. In the description with reference to the accompanying drawings, like reference numerals refer to like elements regardless of the figure number, and redundant explanations are omitted.

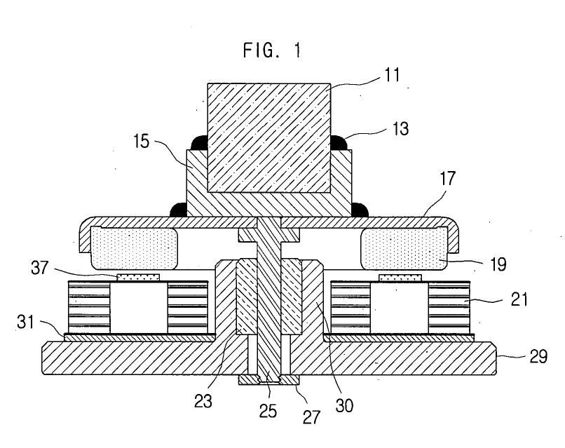

Referring to FIG. 1, an actuator according to an embodiment of the invention includes a base 29, a shaft 25 rotatably joined to the base 29, a case 17 secured to one end of the shaft 25, a magnet 19 mounted on one side of the case 17, coils 21 mounted on the base 29 and facing the magnet 19, a mirror 11 joined to the case 17 and positioned on a light path to reflect light, and a guide 33 having a guide hole 35 in which the mirror 11 is inserted and by which the rotation angle of the mirror 11 can be controlled.

In the actuator according to this embodiment, since the rotation angle of the mirror 11 is controlled by the guide hole 35 of the guide 33, there is no need for a separate control means. Therefore, an actuator according to this embodiment not only allows low power consumption, but also allows easy initialization and control of the position of a mirror.

The mirror 11 is made to vibrate in a particular frequency while secured by a holder 15, and reflects the light emitted from a light source (not shown). The mirror 11, vibrating very rapidly, vibrates the light from the light source, whereby the image projected on the screen becomes smoother and more natural. The mirror 11 is secured to the holder 15 by means of adhesive 13, etc. The angle by which the mirror 11 can rotate is determined by the shape of the guide hole 35 formed in the guide 33.

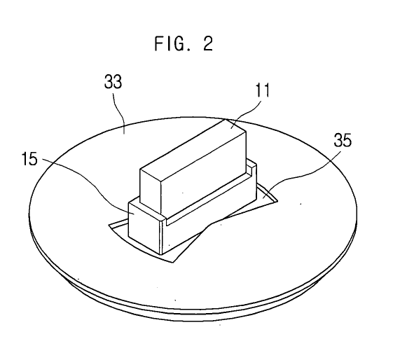

The holder 15 is formed on the upper surface of the case 17 and supports the mirror 11. The holder 15 is secured to the mirror 11 by means of adhesive 13, etc. As illustrated in FIG. 2, the initial position and rotation angle of the holder 15 are controlled by the guide hole 35, as the holder 15 is inserted in the guide hole 35 of the guide 33.

The case 17 is generally shaped as a circular plate, and has the holder 15 formed on its upper surface. The shaft 25 is secured at the center of the lower surface of the case 17 and is made to rotate together with the case 17. Coils 21 are mounted on the lower surface of the case 17, in positions facing the magnet 19. As shown in FIG. 1, by making the diameter of the case 17 slightly shorter than the diameter of the base 29, the driving force may be increased, due to the interaction between the electric force lines formed by the coils 21 and the magnetic force lines generated by the magnet 19.

The magnet 19 attached on the lower surface of the case 17 is a donut-shaped permanent magnet, having alternately magnetized N- and S-poles. The number of pairs of N- and S-poles may be an integer multiple of the number of coils 21. The magnet 19 forms magnetic force lines that interact with the electric force lines formed by the coils 21, to generate the driving force that vibrates the case 17, holder 15, and mirror 11. The position of the magnet 19 is sensed by Hall sensors 37 and recognized by the control unit (not shown), whereby the angle of the magnet 19, holder 15, and mirror 11 may be controlled.

The case 17 is rotatably supported by the shaft 25. One end of the shaft 25 is in contact with a washer 27, while the other end is joined to the case 17. Also, a bearing 23 is interposed between the shaft 25 and the base 29, to allow smoother rotation of the shaft 25.

The base 29 is generally shaped as a circular plate, and has a boss 30 at its center for supporting the shaft 25. A printed circuit board 31 and a number of coils 21 are secured on the upper surface of the base 29. A washer 27 is secured at the center on the lower surface of the base 29, and as the side of the washer 27 that is in contact with the shaft 25 has a superior roughness property, the frictional force accompanying the rotation of the shaft 25 may be reduced. The boss 30 protrudes upwards from the center of the base 29, and a bearing 23 is inserted in the boss 30 for supporting the shaft 25. The boss 30 secures the shaft 25 in a more stable manner, to prevent the vibrating of the shaft 25, which supports the mirror 11, holder 15, and case 17.

The printed circuit board 31 secured to the upper portion of the base 29 is connected with the coils 21 secured to an upper portion thereof, and supplies an electric current to the coils 21. The printed circuit board 31 is connected with an external control unit (not shown), where the electric current inputted to the coils 21 is controlled by the control signals of the control unit. While the printed circuit board 31 is shown attached to the upper surface of the base 29 in FIG. 1, it is apparent that it may be attached on the lower surface of the base 29 or even outside the actuator, as long as it is able to supply an electric current to the coils 21.

The coils 21 are wound coils arranged on the upper portion of the printed circuit board 31 in particular intervals. For example, the arrangement of the coils 21 may be such that three coils 21 are arranged in 120° angles, although the invention is not thus limited. In the coils 21, the flow of the electric current inputted according to the input signals of the control unit (not shown) is repeated with a particular period, whereby the direction of the electric field generated by the coils 21 is changed, so that the case 17, holder 15, and mirror 11 are made to vibrate periodically.

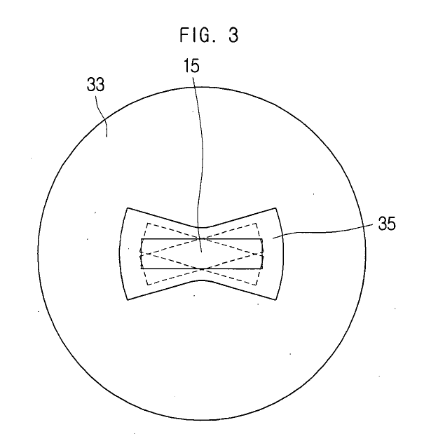

A guide 33 having a guide hole 35 is positioned on the upper part of the case 17. As illustrated in FIG. 1, the guide 33 may be joined to the actuator or may be formed as a part of, for instance, a mobile terminal, etc. The holder 15 is inserted in the guide hole 35,. as is illustrated in FIG. 2. The guide hole 35 has a fan-like shape formed in bilateral symmetry, as in FIG. 3, where the breadth by which holder 15 is able to vibrate is determined by the central angle of the fan-like shape. That is, the guide hole 35 controls the breadth by which the holder 15 vibrates, without disturbing the vibration of the holder 15. As such, an actuator according to this embodiment allows easy control of the direction of the mirror 11. Also, since the holder 15 is positioned inside the guide hole 35, it is not necessary to implement a separate device for initializing the position of the mirror 11 after the operation of the actuator.

Hall sensors 37 are secured on the upper surfaces of the coils 21 in positions facing the magnet 19. A Hall sensor is a silicon semiconductor that uses the effect of electromotive forces created when electrons experience the Lorentz force in a magnetic field such that their direction is curved. The Hall sensors 37 sense the rotation of the magnet 19 and inputs the outputted signals to the control unit (not shown), at which the control unit controls the flow and direction, etc., of the electric current inputted to the printed circuit board 31 based on the signals inputted by the Hall sensors 37. In this way, the number and direction, etc., of vibrations of the mirror 11 are determined.

The following will describe the operation of an actuator according to this embodiment.

The electric current inputted through the printed circuit board 31 is inputted to the coils 21, whereby the coils 21 form an electric field. Also, the magnet 19, as a permanent magnet, forms a magnetic field, where the electric field and magnetic field thus formed interact with each other to generate a driving force that rotates the case 17, holder 15, and mirror 11. The control unit very rapidly converts the electric current inputted to the coils 21 to thereby convert the direction of the electric field and thus convert the driving force on the mirror 11.

As such, the rotating angle of the vibrating holder 15 and mirror 11 is controlled by the guide hole 35. Also, when the operation of the actuator has been stopped, the guide hole 35 prevents the mirror 11 from rotating in a random direction due to inertia of the holder 15 and the mirror 11 itself. Furthermore, the Hall sensors 37 attached on the upper portions of the coils 21 sense the position of the magnet 19, so that the position of the mirror 11 may be controlled with even greater precision.

According to aspects of the invention as set forth above, an actuator applicable to a mobile terminal may be provided.

Also, an actuator may be provided that allows easy initialization and control of the position of a mirror.

While the present invention has been described with reference to particular embodiments, it is to be appreciated that various changes and modifications may be made by those skilled in the art without departing from the spirit and scope of the present invention, as defined by the appended claims and their equivalents.

What is claimed is:

1. An actuator comprising:
a base;
a shaft having one end rotatably joined to the base;
a case secured to the other end of the shaft;
a magnet mounted on one side of the case;
a coil secured to the base such that the coil faces the magnet;
a mirror joined to the case, the mirror positioned on a light path and configured to reflect light; and
a guide having a guide hole capable of controlling the rotation angle of the mirror.

2. The actuator of claim 1, wherein a holder is formed on an upper portion of the case, the holder being configured to secure the mirror,
and wherein the holder is inserted into the guide hole.

3. The actuator of claim 1, further comprising:
a Hall sensor secured to one side of the base and facing the magnet; and
a control unit configured to control the rotation of the mirror using a signal detected by the Hall sensor.

4. The actuator of claim 1, wherein the guide hole has a fan-like shape in bilateral symmetry.

5. The actuator of claim 1, wherein the base has a boss supporting the shaft, and a bearing is interposed between the boss and the shaft.
